(19) United States
(12) Patent Application Publication
(10) Pub. No.: US 2026/0112525 A1
(43) Pub. Date: Apr. 23, 2026

(54) SYSTEMS, METHODS, AND COMPUTER PROGRAM PRODUCTS FOR DISTINGUISHING BETWEEN SURGE TRANSIENT AND TEMPORARY OVERVOLTAGE EVENTS PROCESSED BY A SURGE PROTECTIVE DEVICE

(71) Applicant: RIPD IP DEVELOPMENT LTD, Nicosia (CY)

(72) Inventors: Antony John Surtees, Chagrin Falls, OH (US); Garren Martel, Spokane, WA (US)

(21) Appl. No.: 18/918,583

(22) Filed: Oct. 17, 2024

(51) Int. Cl. H01C 7/12; H02H 9/04

(52) U.S. Cl. CPC H01C 7/126; H02H 9/042

(57) ABSTRACT

A system includes a current detector that is configured to detect current flow events in a varistor of a surge protective device; a comparator circuit that is configured to generate interrupts responsive to detection of the current flow events, respectively; and an event evaluation system that is configured to receive the interrupts and determine whether respective ones of the current flow events are associated with a surge transient event or a temporary overvoltage event responsive to the interrupts.

### BACKGROUND OF THE INVENTION

The present disclosure relates to surge protective devices and, more particularly, to surge protective devices including varistors.

Frequently, excessive voltage or current is applied across service lines that deliver power to residences, commercial, and institutional facilities. Such excess voltage or current spikes (transient overvoltages and surge currents) may result from lightning strikes, for example. The above events may be of particular concern in telecommunications distribution centers, hospitals, and other facilities where equipment damage caused by overvoltages and/or current surges is not acceptable and resulting down time may be very costly.

Typically, sensitive electronic equipment may be protected against transient overvoltages and surge currents using surge protective devices (SPDs). For example, an overvoltage protection device may be installed at a power input of equipment to be protected, which is typically protected against overcurrents until it fails. Typical failure mode of an SPD is a short circuit. The overvoltage protection typically used is a combination of an internal thermal disconnector to protect the device from overheating due to increased leakage currents and an external fuse to protect the device from higher fault currents. Different SPD technologies may avoid the use of the internal thermal disconnector because, in the event of failure, they change their operation mode to a low ohmic resistance. Transient overvoltages and/or surge currents routinely occur on most power distribution systems for multiple reasons. Transients from external sources, such as lightning and utility switching, are commonly recognized as sources of surges and/or transient overvoltages. However, the majority of transient overvoltages originate inside buildings from sources, such as capacitor and motor switching.

In the event of a surge in a line L (e.g., a voltage line of a single or three phase electrical power circuit), protection of power system load devices may necessitate providing a current path to ground for the excess current of the surge current. The surge voltage may generate a transient overvoltage between the line L and the neutral line N (the neutral line N may be conductively coupled to an earth ground PE). Because the transient overvoltage significantly exceeds the operating voltage of the SPD, the SPD will become conductive, allowing the excess current to flow from line L through the SPD to the neutral line N. Once the surge current has been conducted to the neutral line N, the overvoltage condition ends and the SPD may become non-conducting again. The foregoing example describes the use of an SPD between a line L and a neutral line N. In other examples, an SPD may be used between two lines in an L-L application. However, in some cases, one or more SPDs may begin to allow a leakage current to be conducted even at voltages that are lower that the operating voltage of the SPDs. Such conditions may occur in the case of an SPD deteriorating. Handling or processing surge currents and/or transient overvoltages may accelerate the deterioration of an SPD. While many of these surge currents and/or overvoltages may be relatively small, repeated exposure to surge currents and/or overvoltages may degrade the one or more varistors used in an SPD over time.

### SUMMARY

According to some embodiments of the inventive concept, a system comprises: a current detector that is configured to detect current flow events in a varistor of a surge protective device; a comparator circuit that is configured to generate interrupts responsive to detection of the current flow events, respectively; and an event evaluation system that is configured to receive the interrupts and determine whether respective ones of the current flow events are associated with a surge transient event or a temporary overvoltage event responsive to the interrupts.

In other embodiments, the surge protective device is configured to carry current through the varistor in response to an overvoltage event.

In still other embodiments, the surge protective device is electrically coupled to one or more lines of a single phase or multiple phase power system.

In still other embodiments, the current detector comprises: a transformer that is configured to generate induced current events in response to the current flow events in the varistor of the surge protective device, respectively; and a burden resistor that is coupled in parallel to the transformer and is configured to develop event voltages thereacross in response the induced current events, respectively.

In still other embodiments, the system further comprises: a voltage divider network that couples the event voltages and reference voltages to the comparator circuit.

In still other embodiments, the comparator circuit is a window comparator circuit that is configured to receive the event voltages as input voltages, respectively; and the window comparator circuit is configured to generate the interrupts responsive to the input voltages, respectively.

In still other embodiments, each of the interrupts comprises a voltage pulse having a duration based on respective magnitudes of the input voltages and the reference voltages.

In still other embodiments, the event evaluation system is further configured to classify a respective one of the current flow events as a surge transient event when a new interrupt is received and a subsequent interrupt is not received within a defined event completion interval after receiving the new interrupt.

In still other embodiments, the event evaluation system is further configured to classify a respective one of the current flow events as a temporary overvoltage event when a new interrupt is received, a first subsequent interrupt is received after expiration of a defined event start interval after receiving the new interrupt, but within a defined event completion interval of receiving the new interrupt, and a second subsequent interrupt is received after expiration of the defined event start interval after receiving the new interrupt, but within the defined event completion interval of receiving the new interrupt.

In still other embodiments, the event evaluation system is further configured to determine a duration of the temporary overvoltage event based on an elapsed time between the respective one of the current flow events being classified as a temporary overvoltage event and failure of the event evaluation system to receive a next interrupt associated with the temporary overvoltage event within the defined event completion interval of receiving a previous interrupt associated with the temporary overvoltage event.

In some embodiments of the inventive concept, a method comprises: detecting current flow events in a varistor of a surge protective device; generating interrupts responsive to detection of the current flow events, respectively; and determining whether respective ones of the current flow events are associated with a surge transient event or a temporary overvoltage event responsive to the interrupts.

In further embodiments, the surge protective device is configured to carry current through the varistor in response to an overvoltage event.

In still further embodiments, the surge protective device is electrically coupled to one or more lines of a single phase or multiple phase power system.

In still further embodiments, detecting current flow events comprises: generating induced current events in response to the current flow events in the varistor of the surge protective device, respectively; and developing event voltages in response the induced current events, respectively.

In still further embodiments, generating the interrupts comprises generating the interrupts using a comparator circuit, the method further comprising: coupling the event voltages and reference voltages to the comparator circuit

In still further embodiments, the comparator circuit is a window comparator circuit, the method further comprising: receiving the event voltages as input voltages, respectively, at the window comparator circuit; and generating the interrupts using the window comparator circuit responsive to the input voltages, respectively.

In still further embodiments, each of the interrupts comprises a voltage pulse having a duration based on respective magnitudes of the input voltages and the reference voltages.

In still further embodiments, the method further comprises: classifying a respective one of the current flow events as a surge transient event when a new interrupt is received and a subsequent interrupt is not received within a defined event completion interval after receiving the new interrupt.

In still further embodiments, the method further comprises: classifying a respective one of the current flow events as a temporary overvoltage event when a new interrupt is received, a first subsequent interrupt is received after expiration of a defined event start interval after receiving the new interrupt, but within a defined event completion interval of receiving the new interrupt, and a second subsequent interrupt is received after expiration of the defined event start interval after receiving the new interrupt, but within the defined event completion interval of receiving the new interrupt.

In still further embodiments, the method further comprises: determining a duration of the temporary overvoltage event based on an elapsed time between the respective one of the current flow events being classified as a temporary overvoltage event and failure of the event evaluation system to receive a next interrupt associated with the temporary overvoltage event within the defined event completion interval of receiving a previous interrupt associated with the temporary overvoltage event.

In some embodiments of the inventive concept, a computer program product comprises: a non-transitory computer readable storage medium comprising computer readable program code embodied in the medium that is executable by a processor to perform operations comprising: detecting current flow events in a varistor of a surge protective device; generating interrupts responsive to detection of the current flow events, respectively; and determining whether respective ones of the current flow events are associated with a surge transient event or a temporary overvoltage event responsive to the interrupts.

In other embodiments, the surge protective device is configured to carry current through the varistor in response to an overvoltage event.

In still other embodiments, the surge protective device is electrically coupled to one or more lines of a single phase or multiple phase power system.

In still other embodiments, detecting current flow events comprises: generating induced current events in response to the current flow events in the varistor of the surge protective device, respectively; and developing event voltages in response the induced current events, respectively.

In still other embodiments, generating the interrupts comprises generating the interrupts using a comparator circuit, the operations further comprising: coupling the event voltages and reference voltages to the comparator circuit.

In still other embodiments, the comparator circuit is a window comparator circuit, the operations further comprising: receiving the event voltages as input voltages, respectively, at the window comparator circuit; and generating the interrupts using the window comparator circuit responsive to the input voltages, respectively.

In still other embodiments, each of the interrupts comprises a voltage pulse having a duration based on respective magnitudes of the input voltages and the reference voltages.

In still other embodiments, the operations further comprise: classifying a respective one of the current flow events as a surge transient event when a new interrupt is received and a subsequent interrupt is not received within a defined event completion interval after receiving the new interrupt.

In still other embodiments, the operations further comprise: classifying a respective one of the current flow events as a temporary overvoltage event when a new interrupt is received, a first subsequent interrupt is received after expiration of a defined event start interval after receiving the new interrupt, but within a defined event completion interval of receiving the new interrupt, and a second subsequent interrupt is received after expiration of the defined event start interval after receiving the new interrupt, but within the defined event completion interval of receiving the new interrupt.

In still other embodiments, the operations further comprise: determining a duration of the temporary overvoltage event based on an elapsed time between the respective one of the current flow events being classified as a temporary overvoltage event and failure of the event evaluation system to receive a next interrupt associated with the temporary overvoltage event within the defined event completion interval of receiving a previous interrupt associated with the temporary overvoltage event.

Other systems, methods, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a power distribution network including a surge protective device and a surge event classification system according to some embodiments of the inventive concept;

FIG. 2 is a block diagram of the surge event classification system according to some embodiments of the inventive concept;

FIG. 3 is a circuit diagram of the surge event classification system according to some embodiments of the inventive concept;

FIG. 4-7 are flowcharts that illustrate operations of the surge event classification system according to some embodiments of the inventive concept;

FIGS. 8A and 8B are output displays of the surge event classification system for a surge transient event and a temporary overvoltage event, respectively, according to some embodiments of the inventive concept; and

FIG. 9 is a simplified block diagram of a controller used in the event evaluation system of FIG. 2 according to some embodiments of the inventive concept.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term a data processing system may include, but it is not limited to, a hardware element, firmware component, and/or software component.

Some embodiments of the inventive concept stem from a realization that overvoltage events in a power system can generally be grouped into two categories: 1) surge transient (SRG) events, which are associated with a typical lightning discharge or switching event of short duration (e.g., under 1 ms) and singular in nature; and 2) temporary over voltage (TOV) events, which are associated with an abnormal overvoltage condition of the utility power network lasting one or more cycles of the 50/60 Hz main frequency. Some embodiments of the inventive concept may provide an event classification system that can distinguish between the two types of overvoltage events based on their characteristics. A SRG event is deemed to be an event of nature (e.g., lightning, switching, etc.) with a generally short duration that is typically in the microsecond time domain. This may result in a single burst of current through a surge protective device (SPD). Conversely, a TOV event is deemed to be an abnormal state of the power network where an abnormal voltage may last from a few to several hundreds of cycles of the utility power network main frequency (e.g., several milliseconds, seconds, or even minutes). As varistors used in an SPD tend to deteriorate over time and this deterioration may be accelerated by the type, number, and length of overvoltage events processed by the SPD, the ability to recognize and classify the various overvoltage events may allow an administrator to better evaluate the remaining life of an SPD and either maintain or replace an SPD before it fails.

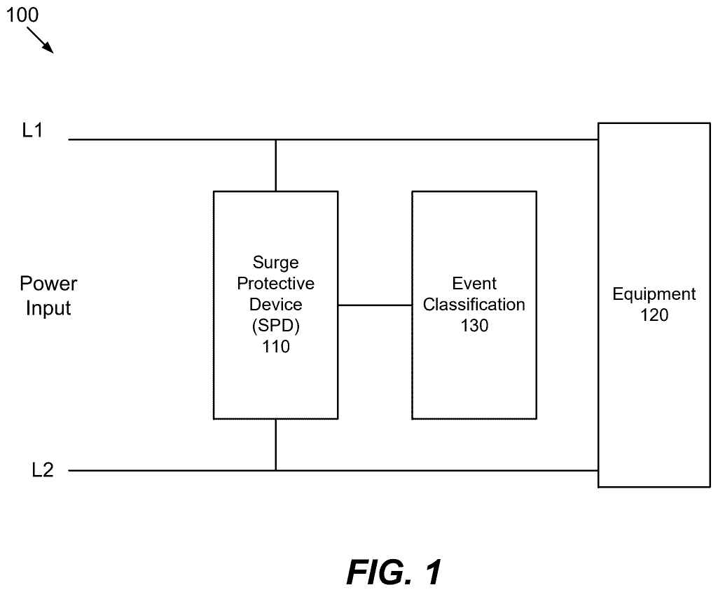

FIG. 1 is a block diagram that illustrates a power distribution network including a surge protective device and a surge event classification system according to some embodiments of the inventive concept. Referring to FIG. 1, a power distribution network 100 may include one or more SPDs 110 that are used to provide overvoltage protection to one or more pieces of equipment 120. The SPDs 110 may be installed at a power input of the equipment to be protected 120. The SPDs 110 protect the equipment against overcurrent by shunting the surge current away from the equipment to another path, such as ground, by way of a short circuit, for example. The overcurrent protection typically used is a combination of an internal thermal disconnector to protect the device from overheating due to increased leakage currents and an external fuse to protect the device from higher fault currents. Different SPD technologies may avoid the use of the internal thermal disconnector because, in the event of failure, they change their operation mode to a low ohmic resistance. In this manner, the device can withstand significant short circuit currents. In this regard, there may be no operational need for an internal thermal disconnector. Further to the above, some embodiments that exhibit even higher short circuit withstand capabilities may also be protected only by the main circuit breaker of the installation without the need for a dedicated branch fuse. The SPDs 110 may be connected between two lines L1 and L2 of the power system, which may represent two different power lines of a single or multi-phase power system or may represent one power line and one neutral line of a multi-phase power system. In some embodiments, the neutral line may be conductive coupled to an earth ground. Although described herein with reference to the power input being an alternating current (AC) power signal generated by a utility power station, in accordance with various embodiments of the inventive concept, the power input may be a direct current (DC) signal and/or a communication signal. In some embodiments, the power input may be a radio frequency (RF) communication signal.

A typical operating voltage of an SPD 110 in the present example may be about 400V (for 690V L-L systems). In this regard, the SPD 110 may be non-conductive during normal operating conditions. In some embodiments, the operating voltage of the SPD 110 is sufficiently higher than the normal line-to-neutral voltage or line-to-line voltage to ensure that the one or more SPDs 110 will continue to perform as an insulator even in cases in which the system voltage increases due to overvoltage conditions that might arise as a result of a loss of neutral or other power system issues.

In the event of an overvoltage resulting in a surge of current in, for example, L1, protection of the equipment 120 may necessitate providing a current path to L2 for the excess current of the surge current. The surge current may generate an overvoltage between L1 and L2. Because the overvoltage significantly exceeds the operating voltage of the one or more SPDs 110, the SPDs 110 will become conductive, allowing the excess current to flow from L1 through the SPDs 110 to L2. Once the surge current has been conducted to L2 and the overvoltage condition ends, the one or more SPDs 110 may become non-conducting again.

The one or more SPDs 110 may include one or more gas discharge tubes (GDTs) and one or more metal oxide varistors (MOV). Both GDTs and MOVs have advantages and drawbacks in shunting current away from sensitive electronic components in response to overvoltage events. For example, MOVs have the advantage of responding rapidly to surge events and being able to dissipate the power associated with surge events. But MOVs have the disadvantages of having increased capacitance relative to GDTs and passing a leakage current therethrough even in ambient conditions. MOVs may also have a decreased lifetime expectancy relative to GDTs. GDTs have the advantage of having extremely low to no leakage current, minimal capacitance, and an increased lifetime expectancy relative to MOVs. But GDTs are not as responsive to surge events as MOVs. Moreover, when a GDT fires and transitions into the arc region in response to a surge event, the GDT may remain in a conductive state if the ambient voltage on the line to which the GDT is connected exceeds the arc voltage.

As described above, the overvoltage events may fall into two categories: SRG events and TOV events. An event classification system 130, according to some embodiments of the inventive concept, may be coupled to the one or more SPDs 110 and may be configured to detect surge currents therethrough. Based on the characteristics of these surge currents, the event classification system 130 may classify the overvoltage event as a SRG event or a TOV event, which can then be used to evaluate the remaining life of the one or more SPD. Based on this evaluation, the one or more SPDs may undergo maintenance or replacement to ensure the one or more SPDs 110 do not leave the equipment vulnerable to future overvoltage events.

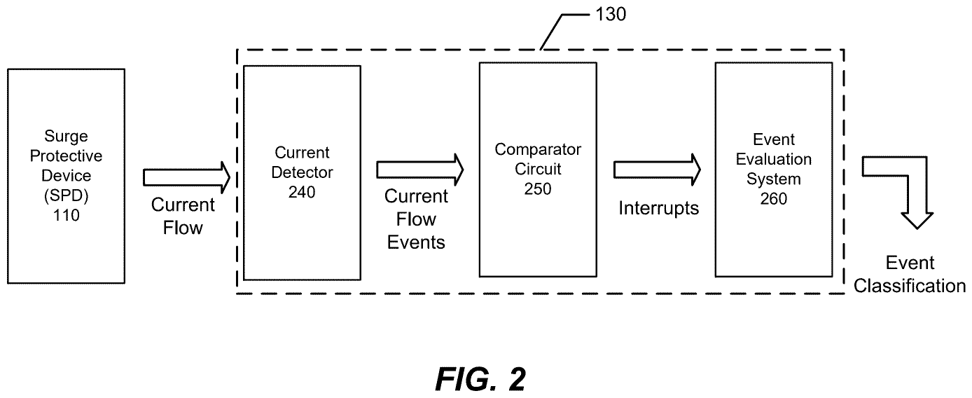

FIG. 2 is a block diagram of the surge event classification system according to some embodiments of the inventive concept. As shown in FIG. 2, the event classification system 130 includes three modules: a current detector module 240, a comparator circuit 250, and an event evaluation system 260. The current detector 240 is configured to detect current flow events in one or more varistors of the one or more SPDs 110. The comparator circuit 250 may be configured to generate interrupts in response to the current flow events detected by the current detector 240. The event evaluation system 260 may be configured determine whether a current flow event is associated with a SRG event or a TOV event based on the interrupts. As the interrupts may correspond to the current flow events, the interrupts may have the same temporal characteristics as the current flow events. Because SRG events and TOV events have different characteristics in terms of number and duration of the current surges, the event evaluation system 260 can distinguish between the two different types of overvoltage events based on these characteristics.

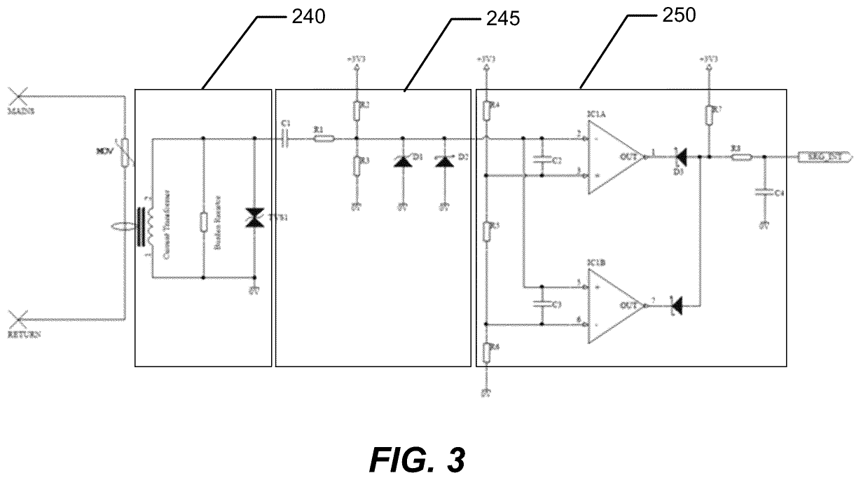

FIG. 3 is a circuit diagram of the surge event classification system according to some embodiments of the inventive concept. As shown in FIG. 3, a surge protective device includes a MOV, which will carry current in response to an overvoltage event. The current detector 240 includes a transformer that is placed in proximity to a line through which the MOV current flows. The MOV current may induce a current in the transformer winding, which results in an event voltage being developed across the burden resistor. A clipping circuit TVS1 may be used to limit the magnitude of the event voltage swings across the burden resistor. A voltage divider network 245 couples the current detector 240 to the comparator circuit 250. The voltage divider network includes resistor R1 and capacitor C1 to couple the event voltage developed across the burden resistor to the comparator circuit 250 as an input voltage. A voltage divider network including resistors R2, R3, R4, and R5 may be used to provide reference voltages to the various input terminals of the comparator circuit 250. The comparator circuit 250 is configured as a window comparator circuit and includes two operational amplifiers (op-amps) C1A and C1B. The comparator circuit 250 receives the input voltage at the negative terminal of the C1A op-amp and the positive terminal of the C1B op-amp. Capacitors C2 and C3 maintain the voltage difference between the input terminals of each of the op-amps C1A and C1B, respectively. The initial switching condition of the comparator circuit 250 is the outputs of both the op-amp C1A and the op-amp C1B is HIGH “ON”.

When the input voltage on negative terminal of op-amp C1A and positive terminal of op-amp C1B is below the lower reference voltage level at the negative terminal of op-amp C1B, the output of the comparator circuit 250 will be LOW. When the input voltage on the negative terminal of op-amp C1A and the positive terminal of op-amp C1B exceeds the lower reference voltage level at the negative terminal of op-amp C1B, the op-amp C1B detects this and switches its open-collector output HIGH. This means that both op-amps C1A and C1B have their outputs HIGH at the same time. No current flows through the pull-up resistor R7 so the output voltage of the comparator circuit 250 is equal to Vcc.

As the input voltage continues to increase it passes the upper reference voltage level at the positive terminal of the op-amp C1A. At this point the op-amp C1A detects this and switches its output LOW and the output voltage of the comparator circuit 250 drops to 0V.

The difference between the upper reference voltage level at the positive terminal of the op-amp C1A and the lower reference voltage level at the negative terminal of op-amp C1B creates the switching window for the input voltage signal when going in the positive direction. The upper reference voltage level at the positive terminal of the op-amp C1A creates the switch point for the input voltage signal when going in the positive direction.

Then the difference between the upper reference voltage level at the positive terminal of the op-amp C1A and the lower reference voltage level at the negative terminal of op-amp C1B creates the window for the input voltage signal when going in the negative direction. The lower reference voltage level at the negative terminal of the comparator C1B creates the switch point for the input voltage signal when going in the negative direction. Thus, as the input voltages passes above or passes below the upper and lower reference voltage levels set by the two op-amp comparators C1A and C1B, the output signal will be HIGH or LOW and output through the low pass filter circuit of resistor R8 and capacitor C4

In the example shown in FIG. 3, if the three voltage divider resistors R4, R5, and R6 are equal, then the upper trip level would be 2/3 Vcc and the lower trip level would be 1/3 Vcc. The trip thresholds for the state changes can be adjusted based on the values of these resistors. The window width, therefore, may be customized for the application.

Thus, the output of the comparator circuit 250 may change states each time the MOV conducts current, irrespective of the direction of the transient causing the conduction. These number and timing of these state changes may be processed by the event evaluation system 260 to determine whether current flow events are associated with a SRG event or TOV event.

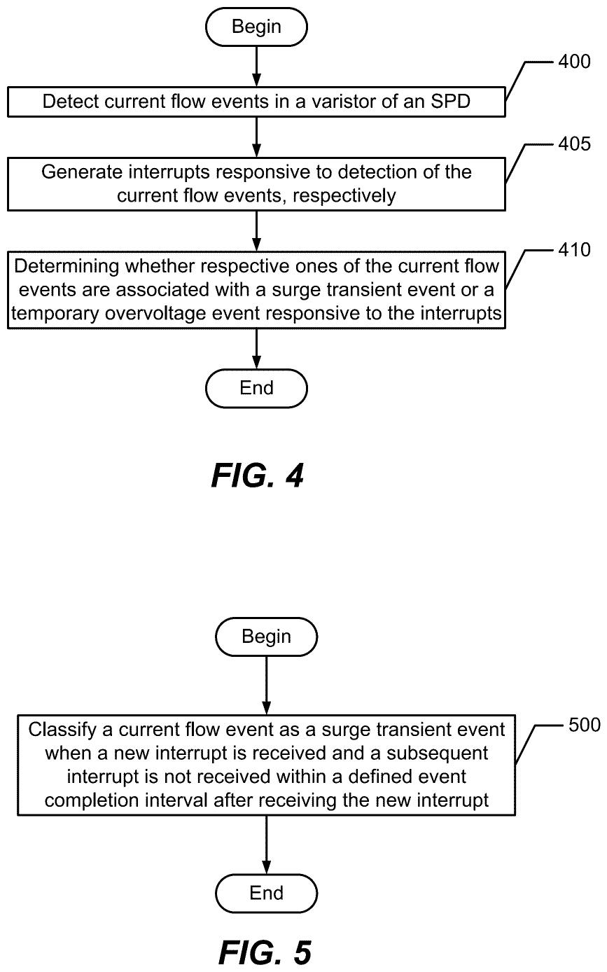

FIG. 4-7 are flowcharts that illustrate operations of the surge event classification according to some embodiments of the inventive concept. Referring now to FIG. 4, operations begin at block 400 where current flow events are detected in a varistor of an SPD. Interrupts are generated at block 405 responsive to the detection of the current flow events, respectively. A determination is made at block 410 whether respective ones of the current flow events are associated with a SRG event or a TOV event responsive to the interrupts.

The interrupts output from the comparator circuit 250 and received at the event evaluation system 260 correspond in number and in time with the overvoltage current events flowing through the MOV in the SPD 110. As a result, these interrupts may be processed and interpreted to classify the overvoltage event processed by the MOV as a SRG event or TOV event. When a new or initial interrupt is received the event evaluation system 260 may set a timestamp to mark the beginning of the event and set a timer. Referring to FIG. 5, a current flow event through the MOV of the SPD 110 may be classified as a SRG event at block 500 when a new interrupt is received and a subsequent interrupt is not received within a defined event completion interval after the new interrupt is received. This is because, as described above, a SRG event is deemed to be an event of nature (e.g., lightning, switching, etc.) with a generally short duration that is typically in the microsecond time domain. Thus, if a second interrupt has not been received before expiration of the event completion interval, then the current flow event through the MOV in the SPD 110 is likely due to a SRG event. In some embodiments, the event completion interval is around 70 ms.

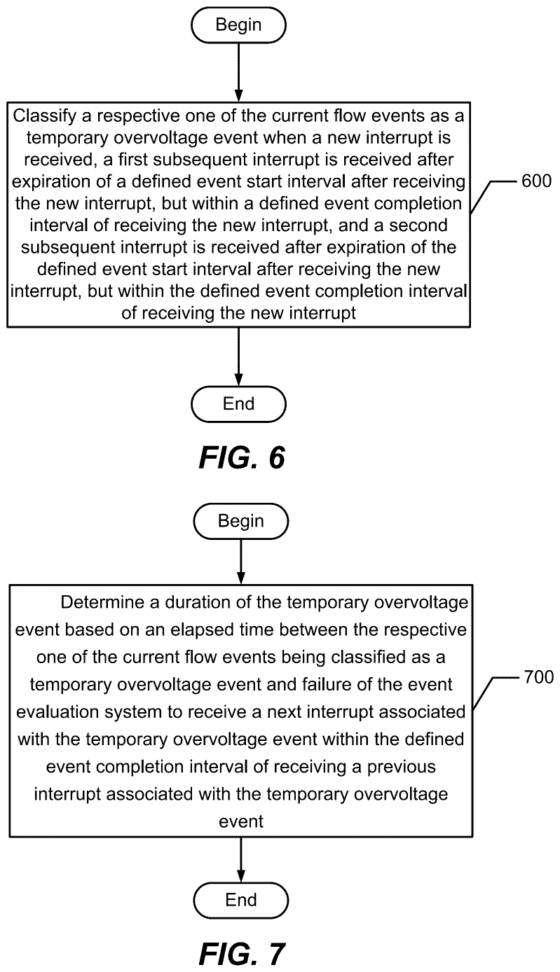

If, however, a first subsequent interrupt is received after the new or initial interrupt is received, then a determination will be made whether at least a defined event start interval time has elapsed at the time of receiving the second interrupt. That is, a determination will be made whether a defined portion of the event completion interval has elapsed at the time the first subsequent interrupt has been received. If the defined event start interval has not elapsed when the first subsequent interrupt is received, the event evaluation system 260 ignores the interrupt and returns to waiting for another interrupt or the expiration of the event completion interval. If, however, the defined event start interval has elapsed, but the event completion interval has not elapsed when the first subsequent interrupt is received, then a counter may be incremented from 0 to 1. Then, if a second subsequent interrupt is received after the first subsequent interrupt, but before the expiration of the event completion interval, the counter may be incremented from 1 to 2 and the timer reset to zero. Once two subsequent interrupts have been received after expiration of the event start interval, but before expiration of the event completion interval the event evaluation system recognizes the overvoltage event as a TOV event. Specifically, referring to FIG. 6, the respective one of the current flow events is classified as a TOV event at block 600 when a new interrupt is received, a first subsequent interrupt is received after expiration of a defined event start interval after receiving the new interrupt, but within a defined event completion interval of receiving the new interrupt, and a second subsequent interrupt is received after expiration of the defined event start interval after receiving the new interrupt, but within the defined event completion interval of receiving the new interrupt. In some embodiments, the defined event start interval may be around 50 ms. As described above, TOV events are characterized as an abnormal voltage that may last from a few to several hundreds of cycles of a utility power network main frequency. This may trigger repeated interrupts over a longer period of time. This different in number of interrupts and temporal characteristic relative to that of a SRG event is used by the event evaluation system 260 to recognize these interrupts as being associated with a TOV event.

Once the second subsequent interrupt is received and the time reset to zero, the event evaluation system continues to process interrupts until the event completion interval expires after receipt of the last interrupt. It is then presumed that the TOV event is completed and a timestamp read that can be used to determine the duration of the TOV event. Such an operation is described in FIG. 7 where a duration of the TOV event is determined at block 700 based on an elapsed time between the respective one of the current flow events being classified as a temporary overvoltage event and failure of the event evaluation system to receive a next interrupt associated with the temporary overvoltage event within the defined event completion interval of receiving a previous interrupt associated with the temporary overvoltage event.

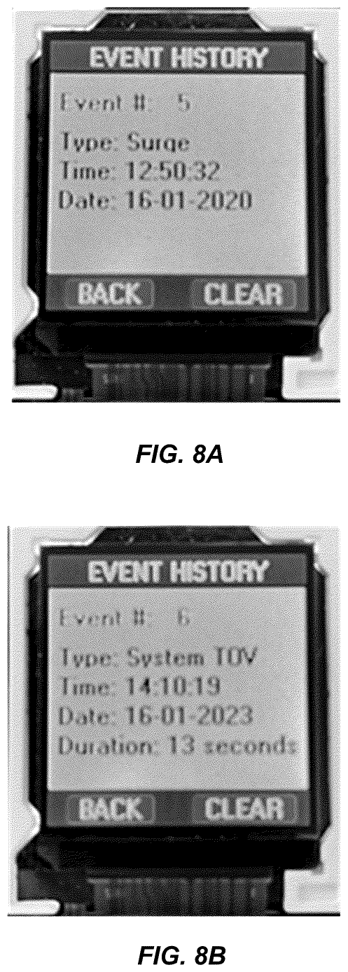

Referring to FIGS. 8A and 8B, the event evaluation system 260 may display the type of event along with the time and date for a SRG event (FIG. 8A) and may display the type, time, date, and duration of a TOV event (FIG. 8B).

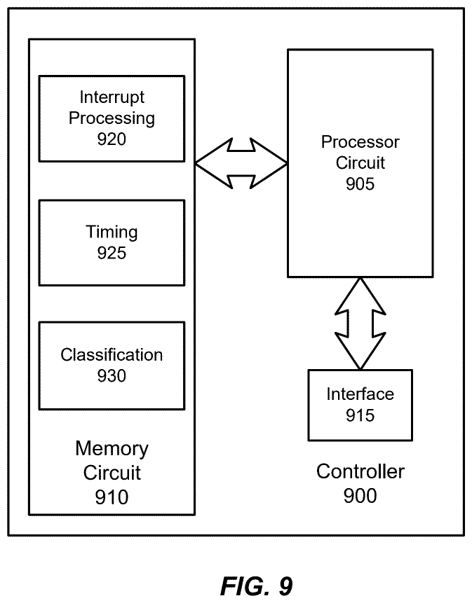

FIG. 9 is a simplified block diagram of a controller used in the event evaluation system of FIG. 2 that is configured to perform operations according to one or more embodiments disclosed herein in accordance with some embodiments of the inventive concept. The controller 900 comprises a processor circuit 905, a memory circuit 910, and an interface 915. The interface may comprise a wireless and/or a wired interface, such as a wireless transceiver and a network adapter. The wireless transceiver and the network adapter may be configured to provide the controller 900 with wireless and wireline communication functionality, respectively. In some embodiments, the interface 915 may support a Joint Test Action Group (JTAG) port for communication. The processor circuit 905 may comprise one or more data processing circuits, such as a general purpose and/or special purpose processor, e.g., microprocessor and/or digital signal processor. The processor circuit 905 is configured to execute computer readable program code including an interrupt processing module 920, a timing module 925, and a classification module 930 in the memory circuit 910 to perform at least some of the operations described herein as being performed by the event classification system 130. The interrupt processing module 920 may be configured to receive an analyze the interrupts output from the comparator circuit 250 in accordance with some embodiments of the inventive concept. The timing module 925 may be configured to generate and control the timers used in evaluating when an overvoltage event has completed (defined event completion interval timing) and for use in generating the timing between interrupts (defined event start interval for evaluating potential TOV events) to determine whether an overvoltage event is a SRG event or TOV event in accordance with some embodiments of the inventive concept. The classification module 930 may be configured to perform one or more operations of the event evaluation system 260 ad the flowcharts of FIG. 4-7 in classifying an overvoltage event as a SRG event or TOV event in accordance with some embodiments of the inventive concept.

Some embodiments of the inventive concept may provide an event classification system that can distinguish between SRG overvoltage events, which are typically events of nature that are relatively short in duration, and TOV overvoltage events, which are typically associated with an abnormal state of a power network, which are frequently more long lasting and may be synchronized with the utility power network main frequency. As overvoltage events may tend to accelerate the deterioration of varistors used in SPDs, by recognizing and characterizing the various overvoltage events processed by an SPD, an administrator may have insight into the state and remaining life of an SPD and may be able to maintain or replace an SPD before it fails.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive subject matter.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present disclosure of embodiments has been presented for purposes of illustration and description, but is not intended to be exhaustive or limited to the disclosure in the form disclosed. Many variations and modifications can be made to the embodiments without substantially departing from the principles of the present invention. All such variations and modifications are intended to be included herein within the scope of the present invention.

What is claimed is:

1. A system, comprising:
a current detector that is configured to detect current flow events in a varistor of a surge protective device;
a comparator circuit that is configured to generate interrupts responsive to detection of the current flow events, respectively; and
an event evaluation system that is configured to receive the interrupts and determine whether respective ones of the current flow events are associated with a surge transient event or a temporary overvoltage event responsive to the interrupts.

2. The system of claim 1, wherein the surge protective device is configured to carry current through the varistor in response to an overvoltage event.

3. The system of claim 1, wherein the surge protective device is electrically coupled to one or more lines of a single phase or multiple phase power system.

4. The system of claim 1, wherein the current detector comprises:
a transformer that is configured to generate induced current events in response to the current flow events in the varistor of the surge protective device, respectively; and
a burden resistor that is coupled in parallel to the transformer and is configured to develop event voltages thereacross in response the induced current events, respectively.

5. The system of claim 4, further comprising:
a voltage divider network that couples the event voltages and reference voltages to the comparator circuit.

6. The system of claim 5, wherein the comparator circuit is a window comparator circuit that is configured to receive the event voltages as input voltages, respectively; and
wherein the window comparator circuit is configured to generate the interrupts responsive to the input voltages, respectively.

7. The system of claim 6, wherein each of the interrupts comprises a voltage pulse having a duration based on respective magnitudes of the input voltages and the reference voltages.

8. The system of claim 6, wherein the event evaluation system is further configured to classify a respective one of the current flow events as a surge transient event when a new interrupt is received and a subsequent interrupt is not received within a defined event completion interval after receiving the new interrupt.

9. The system of claim 6, wherein the event evaluation system is further configured to classify a respective one of the current flow events as a temporary overvoltage event when a new interrupt is received, a first subsequent interrupt is received after expiration of a defined event start interval after receiving the new interrupt, but within a defined event completion interval of receiving the new interrupt, and a second subsequent interrupt is received after expiration of the defined event start interval after receiving the new interrupt, but within the defined event completion interval of receiving the new interrupt.

10. The system of claim 9, wherein the event evaluation system is further configured to determine a duration of the temporary overvoltage event based on an elapsed time between the respective one of the current flow events being classified as a temporary overvoltage event and failure of the event evaluation system to receive a next interrupt associated with the temporary overvoltage event within the defined event completion interval of receiving a previous interrupt associated with the temporary overvoltage event.

11. A method, comprising:
detecting current flow events in a varistor of a surge protective device;
generating interrupts responsive to detection of the current flow events, respectively; and
determining whether respective ones of the current flow events are associated with a surge transient event or a temporary overvoltage event responsive to the interrupts.

12. The method of claim 11, wherein the surge protective device is configured to carry current through the varistor in response to an overvoltage event.

13. The method of claim 11, wherein the surge protective device is electrically coupled to one or more lines of a single phase or multiple phase power system.

14. The method of claim 11, wherein detecting current flow events comprises:
generating induced current events in response to the current flow events in the varistor of the surge protective device, respectively; and
developing event voltages in response the induced current events, respectively.

15. The method of claim 14, wherein generating the interrupts comprises generating the interrupts using a comparator circuit, the method further comprising:
coupling the event voltages and reference voltages to the comparator circuit.

16. The method of claim 15, wherein the comparator circuit is a window comparator circuit, the method further comprising:
receiving the event voltages as input voltages, respectively, at the window comparator circuit; and
generating the interrupts using the window comparator circuit responsive to the input voltages, respectively.

17. The method of claim 16, wherein each of the interrupts comprises a voltage pulse having a duration based on respective magnitudes of the input voltages and the reference voltages.

18. The method of claim 16, further comprising:
classifying a respective one of the current flow events as a surge transient event when a new interrupt is received and a subsequent interrupt is not received within a defined event completion interval after receiving the new interrupt.

19. The method of claim 16, further comprising:
classifying a respective one of the current flow events as a temporary overvoltage event when a new interrupt is received, a first subsequent interrupt is received after expiration of a defined event start interval after receiving the new interrupt, but within a defined event completion interval of receiving the new interrupt, and a second subsequent interrupt is received after expiration of the defined event start interval after receiving the new interrupt, but within the defined event completion interval of receiving the new interrupt.

20. The method of claim 19, further comprising:
determining a duration of the temporary overvoltage event based on an elapsed time between the respective one of the current flow events being classified as a temporary overvoltage event and failure of the event evaluation system to receive a next interrupt associated with the temporary overvoltage event within the defined event completion interval of receiving a previous interrupt associated with the temporary overvoltage event.
